(19) United States
(12) Patent Application Publication
(10) Pub. No.: US 2011/0195041 A1
(43) Pub. Date: Aug. 11, 2011

(54) ANTIMICROBIAL COMPOSITIONS

(75) Inventors: Bret Ja Chisholm, West Fargo, ND (US); Dean C. Webster, Fargo, ND (US); Alexander John Kugel, Woodbury, MN (US)

(73) Assignee: NDSU RESEARCH FOUNDATION, Fargo, ND (US)

(21) Appl. No.: 13/123,318

(22) PCT Filed: Oct. 12, 2009
(86) PCT No.: PCT/US2009/060388

§ 371 Date: Apr. 8, 2011

Related U.S. Application Data
(60) Provisional application No. 61/104,503, filed on Oct. 10, 2008.

(51) Int. Cl. C08G 71/04; A01N 33/00; A01P 1/00

(52) U.S. Cl. 424/78.17; 525/453

(57) ABSTRACT

Provided are antimicrobial compositions including at least one biocide covalently bound to a polyurethane. The biocide moiety may comprise triclosan, a triclosan derivative, or a quaternary ammonium salt. Further provided are methods of reducing biofilm formation or microbial growth on a surface, the method including applying to the surface an antimicrobial composition including at least one biocide covalently attached to a polyurethane.

### CROSS-REFERENCE TO RELATED APPLICATIONS

This application claims priority to U.S. Provisional Patent Application No. 61/104,503, filed Oct. 10, 2008 and incorporated by reference in its entirety.

### STATEMENT REGARDING FEDERALLY SPONSORED RESEARCH AND DEVELOPMENT

This invention was made with government support under grant N00014-07-1-1099 awarded by The Office of Naval Research (ONR). The United States Government has certain rights in the invention.

### BACKGROUND

The invention relates to antimicrobial or biocidal compositions. It is desired to eliminate or prevent the growth of unwanted organisms, for example, to combat the spread of infectious disease in hospitals, mold and mildew on architectural surfaces, biofouling on marine vessels, and pathogenic microorganisms in the home. Due to the significance of the microorganism problem, new antimicrobial materials are needed.

### BRIEF SUMMARY OF THE INVENTION

In one embodiment, the invention provides a polyurethane having at least one antimicrobial moiety covalently bound to the polymer. In another embodiment, the invention provides a polyol having at least on antimicrobial moiety covalently bound to the polyol.

In yet another embodiment, the invention provides antimicrobial compositions comprising a polyurethane having at least one antimicrobial moiety covalently bound to the polyurethane.

In another embodiment, the invention provides a method of reducing formation of a biofilm on a surface, the method including applying to the surface a polyurethane having at least one antimicrobial moiety covalently bound to the polyurethane. The surface may include a marine surface, a medical surface, or a household surface.

In yet another embodiment, the invention provides a method of reducing microbial growth on a surface, the method including applying to the surface a polyurethane having at least one antimicrobial moiety covalently bound to the polyurethane. The surface may include a marine surface, a medical surface, or a household surface.

In another embodiment, the invention provides a medical device including a polyurethane having at least one antimicrobial moiety covalently bound to the polyurethane.

### BRIEF DESCRIPTION OF THE DRAWINGS

FIG. 1 is a schematic diagram of compositions of synthesized acrylic polyols according to one aspect of the invention.

FIG. 2 is a ¹H-NMR spectrum of 5% hydroxyethyl acrylate-containing acrylic polyols.

FIG. 3 is a schematic diagram of compositions of polyurethane compositions synthesized from acrylic polyols according to one aspect of the invention.

FIG. 4 is a graph of the minimum inhibitory concentration (MIC) of triclosan as a measurement of the antimicrobial activity towards four microorganisms.

FIG. 5 are graphs of the toxicity of leachates from polyurethane compositions.

FIG. 6 is a graph of the reduction in C. lytica biofilm obtained with the polyurethane compositions described in FIG. 3.

FIG. 7 is a graph of the reduction in S. epidermidis biofilm obtained with the polyurethane compositions described in FIG. 3.

FIG. 8 is a graph of the reduction in E. coli biofilm obtained with the polyurethane compositions described in FIG. 3.

FIG. 9 is a graph of the reduction in N. incerta biofilm obtained with the polyurethane compositions described in FIG. 3.

FIG. 10 are zones of microbial inhibition for polyurethane compositions comprising polyols containing quaternary ammonium salt (QAS) moieties and soaked in silver nitrate, as determined by the agar diffusion assay. (−,−) indicates no surface inhibition and no zone of inhibition; (+,−) indicates surface inhibition but no zone of inhibition; and (+,+) indicates surface inhibition and a zone of inhibition.

### DETAILED DESCRIPTION

A novel polyurethane and an antimicrobial composition containing the polyurethane have been discovered. The antimicrobial composition of the present invention may suitably be used for biomedical devices, medical surfaces and other objects present in hospitals or doctor offices, marine surfaces, household surfaces, or in any other setting in which antimicrobial activity is desired.

The antimicrobial compositions of the present invention comprise at least one antimicrobial or biocidal moiety covalently bound to a polyurethane. As one of ordinary skill in the art would understand, polyurethanes may be synthesized by reacting a polyol with a polyisocyanate, optionally in the presence of a catalyst or initiator. Suitable catalysts or initiators are known in the art and example include, but are not limited to, 1,4-diazabicyclo[2.2.2]octane (DAB CO), dimethylcyclohexylamine (DMCHA), dimethylethanolamine (DMEA), tetramethylbutanediamine (TMBDA), pentamethyldipropylenetriamine, N-(3-dimethylaminopropyl)-N,N-diisopropanolamine, triethylamine (TEA), 1,8-diazabicyclo[5.4.0]undecene-7 (DBU), pentamethyldiethylenetriamine (PMDETA), benzyldimethylamine (BDMA), N,N,N′-trimethyl-N′-hydroxyethylbis(aminoethyl)ether, N′-(3-(dimethylamino)propyl)-N,N-dimethyl-1,3-propanediamine, dibutyltin dilaurate (DBTDL), dibutyltin diacetate (DBTDAc), bismuth octanoate, dioctyltin mercaptide, and dibutyltin oxide. The catalyst or initiator may be present in an amount of about 0.001%-1% by weight of the reaction. Suitable solvents for reaction are known in the art and example may include, but are not limited to, toluene, acetone, xylene, solvent naphtha, butyl acetate, and ethyl acetate.

The polyurethane may comprise alternating copolymers, periodic copolymers, statistical copolymers, or combinations thereof. The polyurethane may comprise a block co-polymer, polymer, for example, diblock copolymers, triblock copolymers, triblock terpolymers, or combinations thereof. The polyurethane may comprise cross-linked polymers or monomers or combinations thereof. Polyurethanes suitable for use in the invention range from urethane oligomers, with only about 100 monomers, to large polymers having 10,000 or more monomers.

Monomers used to form the polyol suitably include, but are not limited to, hydroxyethyl acrylate, butyl acrylate, methyl acrylate, ethyl acrylate, acrylic acid, methacrylic acid, acrylamide, methacrylamide, 2-ethylhexyl acrylate, acrylonitrile, methyl methacrylate, butyl methacrylate, ethyl methacrylate, trimethylolpropane triacrylate, hydroxyethyl methacrylate, 2-hydroxyethyl methacrylate, hydroxypropyl acrylate, 3-hydroxypropyl acrylate, hydroxypropyl methacrylate, 3-hydroxypropyl methacrylate, 2-ethylhexyl acrylate, 2-ethylhexyl methacrylate, styrene, 2,2,2-trifluoroethyl alpha fluoroacrylate, 2,2,3,3,-tetrafluoropropyl alpha fluoroacrylate, 2,2,2-trifluoroethyl methacrylate, 2,2,3,3,-tetrafluoropropyl methacrylate, 2,2,3,3,4,4,4-heptafluorobutyl acrylate, 2,2,3,3,3-pentafluoropropyl alpha fluoroacrylate, 2,2,2-trifluoroethyl acrylate, 2,2,3,3-tetrafluoropropyl methacrylate, 2,2,3,3,3-pentafluoropropyl methacrylate, 2,2,3,3,4,4,5,5,6,6,7,7-Dodecafluoroheptyl acrylate, 3,3,4,4,5,5,6,6,7,7,8,8,9,9,10,10,11,12,12,12-Eicosafluoro-11-(trifluoromethyl)dodecyl methacrylate, 4,4,5,5,6,6,7,7,8,9,9,9-Dodecafluoro-2-hydroxy-8-(trifluoromethyl)nonyl methacrylate, 3,3,4,4,5,5,6,6,7,8,8,8-Dodecafluoro-7-(trifluoromethyl)octyl acrylate, 2,2,3,3,4,4,5,5,6,6,7,7,8,8,9,9,10,10,11,11-Eicosafluoroundecyl acrylate, 3,3,4,4,5,5,6,6,7,8,8,8-Dodecafluoro-7-(trifluoromethyl)octyl methacrylate, 2-[Ethyl[(heptadecafluorooctyl)sulfonyl]amino]ethyl acrylate, 3,3,4,4,5,5,6,6,7,7,8,8,9,9,10,10,11,11,12,12,12-Heneicosafluorododecyl acrylate, 3,3,4,4,5,5,6,6,7,7,8,8,9,9,10,10,11,11,12,12,12-Heneicosafluorododecyl methacrylate, 2-[Ethyl[(heptadecafluorooctyl)sulfonyl]amino]ethyl methacrylate, 4,4,5,5,6,6,7,7,8,8,9,9,10,10,11,11,11-Heptadecafluoro-2-hydroxyundecyl acrylate, 3,3,4,4,5,5,6,6,7,7,8,8,9,9,10,10,10-Heptadecafluorodecyl methacrylate, 3,3,4,4,5,5,6,6,7,7,8,8,9,9,10,10,10-Heptadecafluorodecyl acrylate, 2,2,3,3,4,4,4-Heptafluorobutyl acrylate, 2,2,3,3,4,4,4-Heptafluorobutyl methacrylate, 3,3,4,4,5,5,6,6,7,7,8,8,9,10,10,10-Hexadecafluoro-9-(trifluoromethyl) decyl acrylate, 2,2,3,4,4,4-Hexafluorobutyl acrylate, 2,2,3,4,4,4-Hexafluorobutyl methacrylate, 1,1,1,3,3,3-hexafluoropropan-2-yl acrylate, 1,1,1,3,3,3-hexafluoropropan-2-yl methacrylate, 2,2,3,3,4,4,5,5,6,6,7,7,8,8,9,9-Hexadecafluorononyl acrylate, 3,3,4,4,5,5,6,6,7,7,8,8,9,10,10,10-Hexadecafluoro-9-(trifluoromethyl) decyl methacrylate, 2,2,3,3,4,4,5,5,6,6,7,7,8,8,9,9-Hexadecafluorononyl methacrylate, 3,3,4,4,5,5,6,6,6,-Nonafluorohexyl methacrylate, 4,4,5,5,6,6,7,7,7-Nonafluoro-2-hydroxyheptyl acrylate, 4,4,5,5,6,7,7,7-Octafluoro-2-hydroxy-6-(trifluoromethyl)heptyl methacrylate, 4,4,5,5,6,7,7,7-Octafluoro-2-hydroxy-6-(trifluoromethyl)heptyl acrylate, 2,2,3,3,4,4,5,5-Octafluoropentyl acrylate, 2,2,3,3-Tetrafluoropropyl acrylate, 2,2,3,3,4,4,5,5-Octafluoropentyl methacrylate, 1,1,1,3,3,3-Hexafluoroisopropyl methacrylate, 4,4,5,5,6,6,7,7,8,8,9,9,9-Tridecafluoro-2-hydroxynonyl acrylate, 3,3,4,4,5,6,6,6-Octafluoro-5-(trifluoromethyl)hexyl acrylate, 3,3,4,4,5,5,6,6,7,7,8,8,8-Tridecafluorooctyl acrylate, 3,3,4,4,5,6,6,6-Octafluoro-5-(trifluoromethyl)hexyl methacrylate, 2,2,2-Trifluoroethyl acrylate, 2,2,3,3,3-Pentafluoropropyl acrylate, 2-(Trifluoromethyl)acrylic acid, methacryloxypropylpentamethyl-disiloxane, methacryloxypropyltris(trimethyl-siloxy)silane, methacryloxymethyltris-(trimethylsiloxy)silane, 3-methacryloxypropylbis(trimethyl-siloxy)methylsilane, N,N-dimethylaminoethyl acrylate, N,N-dimethylaminoethyl methacrylate, N,N-diethylaminoethyl methacrylate, tert-butylaminoethyl methacrylate, N-methylolacrylamide, Diallyldimethylammonium chloride, N,N-dimethylacrylamide, N,N,N-triethyl-2-(methacryloyloxy)ethanaminium iodide, 2-(acryloyloxy)-N,N,N-trimethylethanaminium iodide, 2-(acryloyloxy)-N,N,N-triethylethanaminium, 2-(acryloyloxy)-N,N,N-trimethylethanaminium iodide, 5-chloro-2-(2,4-dichlorophenoxy)phenyl acrylate (triclosan acrylate), 5-chloro-2-(2,4-dichlorophenoxy)phenyl methacrylate (triclosan methacrylate), and combinations thereof. The monomer may also be a monomer derived from triclosan, such as the triclosan acrylate detailed in Example 1.

The antimicrobial moiety may be covalently attached to the polyurethane directly or via a linker. The antimicrobial moiety may be pendant, i.e. not comprised within the backbone of a polymer. In one embodiment of the invention, the antimicrobial moiety is covalently attached to a functionalized polyol. The ratio of antimicrobial moieties to hydroxyl groups may be from 100:1 to 1:1 or 75:1 to 1:1 or 50:1 to 1:1 or 25:1 to 1:1 or 10:1 to 1:1 or 5:1 to 1:1. The functionalized polyol may be of formula (I):

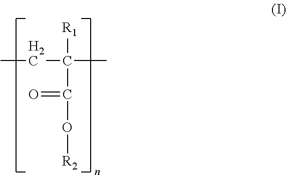

wherein n is an integer greater than or equal to 10, suitably between 10 and 10,000, between 10 and 5,000, or between 10 and 1,000; each R¹ is independently selected from the group consisting of hydrogen and alkyl; and each R₂ is independently selected from the group consisting of alkyl, aryl, siloxane, and an antimicrobial moiety, wherein at least one R₂ is an antimicrobial moiety and at least one R₂ contains a hydroxyl. The alkyl or aryl may be unsubstituted or substituted. The alkyl or aryl may be substituted with hydroxyl.

Any antimicrobial or biocidal agent capable of being attached covalently to the polyurethane may be used. The antimicrobial moiety may be triclosan or a triclosan derivative. Suitably, the triclosan derivative is of formula (III):

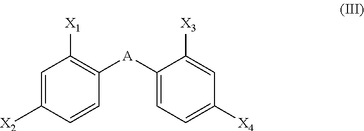

wherein A is selected from O or S;
wherein X₁, X₂, X₃ and X₄ are independently selected from F, Cl, Br and OH.

The antimicrobial moiety may be a quaternary ammonium salt (QAS). Suitably, the QAS is of formula (II):

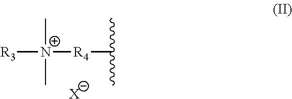

wherein R₃ is an alkyl; R₄ is alkylene, arylene, or heteroarylene; and X is an anion.

Examples of antimicrobial or biocidal moieties include, but are not limited to, pesticides, insecticides, herbicides, fungicides, nematicides, acaricides, bactericides, rodenticides, miticides, algicides, germicides, repellents, disinfectants, preservatives, antibiotics, and antifouling products. Specifically, antimicrobial or biocidal moieties further include, but are not limited to, 2-methylthio-4-butylamino-6-cyclopropylamine-s-triazine (Irgarol 1051), 2,3,5,6-tetrachloro-4-(methylsulfonyl)pyridine (TCMSpyridine), (2-thiocyanomethylthio)benzothiazole (TCMTB), (4,5-dichloro-2-n-octyl-4-isothazolin-3-one) (Sea-NIne 211), (2,4,5,6-tetrachloroisophthalonitrile) (chlorothalonil), 3-(3,4-dichlorophenyl)1,1-dimethylurea (diuron), 2,4,6-trichlorophenylmaleimide, bis(dimethylthiocarbamoyl)disulfide (Thiram), 3-iodo-2-propynyl butylcarbamate, N,N-dimethyl-N′-phenyl(N′-fluorodichloromethyl-thiosulfamide (Dichlorofluanid), N-(fluorodichloromethylthio)phthalimide, diiodomethyl-p-tolysulfone, 5,6-dihydroxy-3-(2-thienyl)-1,4,2-oxathiazine, 4-oxide, 5,7-dichloro-8-hydroxy-2-methylquinoline, 2,5,6-tribromo-1-methylgramine, (3-dimethylaminomethyl-2,5,6-tribromo-1-methylindole)2,3-dibromo-N-(6-chloro-3-pyridyl)succinimide, thiazoleureas, 3-(3,4-dichlorophenyl)-5,6-dihydroxy-1,4,2-oxathiozine oxide, 2-trifluoromethyl-3-bromo-4-cyano-5-parachlorophenyl pyrrole, 2-bromo-4′-chloroacetanilide, 2,6-bis(2′,4′-dihydroxybenzyl)-4-methylphenyl, 2,2-bis(3,5-dimethoxy-4-hydroxyphenyl)propane, acylphloroglucinols: 2,6-diacyl-1,3,5-trihydroxybenzene, guanidines such as 1,3-dicyclohexyl-2-(3-chlorophenyl)guanidine, alkylamines such as auryldimethylamine, dialkylphosphonates such as phosphoric acid di(2-ethylhexylester), alkyl haloalkyl disulfides such as n-octylchloromethyl disulfide and 4,5-dicyano-1,3-dithiole-2-thione, enzymes such as endopeptidase and glucose oxidase and lysozyme, antimicrobial peptides such as Polymyxin B and EM49 and bacitracin, and natural products such as vancomycin and chitosan. Suitably, the antimicrobial or biocidal moiety comprises or is modified to comprise a functional group, such as hydroxyl, for covalent attachment to the polyurethane.

As used herein, an “alkyl” group is a saturated or unsaturated carbon chain having 1 to 22 carbon atoms. An alkyl group may be branched or unbranched and it may be substituted or unsubstituted. Substituents may also be themselves substituted. Suitably, substituents include, but are not limited to, halo, amino, alkoxy, hydroxyl, cyano, acyloxy, aryloxy, aryl, heteroaryl, alkyl, heteralkyl, carbamoyloxy, carboxy, mercapto, alkylthio, acylthio and arylthio. Suitably, the alkyl group may be a lower alkyl group of from 1 to 4 carbon atoms, such as methyl, ethyl, propyl, isopropyl or butyl. “Alkylene” refers a divalent alkyl group.

As used herein, an “alkenyl” group refers to an unsaturated aliphatic hydrocarbon moiety including straight chain and branched chain groups. Alkenyl moieties must contain at least one alkene. “Alkenyl” may be exemplified by groups such as ethenyl, n-propenyl, isopropenyl, n-butenyl and the like. Alkenyl groups may be substituted or unsubstituted. Substituents may also be themselves substituted. When substituted, the substituent group is preferably alkyl, halogen or alkoxy. Substituents be placed on the alkene itself and also on the adjacent member atoms or the alkynyl moiety “C₂-C₄ alkenyl” refers to alkenyl groups containing two to four carbon atoms. “Alkenylene” refers to a divalent alkenyl group.

As used herein, an “alkynyl” group refers to an unsaturated aliphatic hydrocarbon moiety including straight chain and branched chain groups. Alkynyl moieties must contain at least one alkyne. “Alkynyl” may be exemplified by groups such as ethynyl, propynyl, n-butynyl and the like. Alkynyl groups may be substituted or unsubstituted. When substituted, the substituent group is preferably alkyl, amino, cyano, halogen, alkoxyl or hydroxyl. Substituents may also be themselves substituted. Substituents are not on the alkyne itself but on the adjacent member atoms of the alkynyl moiety. “C₂-C₄ alkynyl” refers to alkynyl groups containing two to four carbon atoms. “Alkynylene” refers to a divalent alkynyl group.

As used herein, an “acyl” or “carbonyl” group refers to the group —C(O)R wherein R is alkyl, alkenyl, alkynyl, alkyl alkynyl, aryl, heteroaryl, carbocyclic, heterocarbocyclic, C₁-C₄ alkyl aryl, or C₁-C₄ alkyl heteroaryl. C₁-C₄ alkylcarbonyl refers to a group wherein the carbonyl moiety is preceded by an alkyl chain of 1-4 carbon atoms.

As used herein, an “alkoxy” group refers to the group —O—R wherein R is acyl, alkyl alkenyl, alkyl alkynyl, aryl, carbocyclic, heterocarbocyclic, heteroaryl, C₁-C₄ alkyl aryl or C₁-C₄ alkyl heteroaryl.

As used herein, an “amino” group refers to the group —NR′R′ wherein each R′ is, independently, hydrogen, alkyl, aryl, heteroaryl, C₁-C₄ alkyl aryl, or C₁-C₄ alkyl heteroaryl. The two R′ groups may themselves be linked to form a ring.

As used herein, an “aryl” group is an aromatic hydrocarbon system. Aryl groups may be monocyclic or fused bicyclic ring systems. Monocyclic aryl groups have from 5 to 10 ring atoms, more suitably from 5 to 7 ring atoms, or 5 to 6 ring atoms. Bicyclic aryl groups have from 8 to 12 ring atoms, more suitably from 9 to 10 ring atoms. Aryl groups may be substituted or unsubstituted. Suitably, substituents include, but are not limited to, halo, amino, alkoxy, hydroxyl, cyano, acyloxy, aryloxy, aryl, heteroaryl, alkyl, heteroalkyl, carbamoyloxy, carboxy, mercapto, alkylthio, acylthio and arylthio. Suitable aryl groups include phenyl and substituted phenyl. “Arylene” refers to a divalent aryl group.

As used herein, a “carboxyl” group refers to the group —C(═O)O—C₁-C₄ alkyl.

As used herein, a “carbonylamino” group refers to the group —C(O)NR′R′ wherein each R′ is, independently, hydrogen, alkyl, aryl, cycloalkyl; heterocycloalkyl; heteroaryl, C₁-C₄ alkyl aryl or C₁-C₄ alkyl heteroaryl. The two R′ groups may themselves be linked to form a ring.

As used herein, “halo” is fluoro, chloro, bromo, or iodo.

As used herein, “heteroatom” is a nitrogen, sulfer or oxygen atom. Groups containing more than one heteroatom may contain different heteroatoms.

As used herein, a “heteroaryl” group is an aromatic ring system containing carbon and from 1 to about 4 heteroatoms in the ring. Heteroaryl rings are monocyclic or fused bicyclic ring systems. Monocyclic heteroaryl rings contain from about 5 to about 10 member atoms (carbon and heteroatoms), preferably from 5 to 7, and most preferably from 5 to 6 in the ring. Bicyclic heteroaryl rings contain from 8 to 12 member atoms, preferably 9 or 10 member atoms in the ring. Heteroaryl rings may be unsubstituted or substituted with from 1 to about 4 substituents on the ring. Suitable substituents include, but are not limited to, halo, amino, alkoxy, hydroxyl, cyano, acyloxy, aryloxy, aryl, heteroaryl, alkyl, heteroalkyl, carbamoyloxy, carboxy, merapto, alkylthio, acylthio and arylthio. Suitable heteroaryl rings include thienyl, thiazolo, purinyl, pyrimidyl, pyridyl, and furanyl. “Heteroarylene” refers to a divalent heteroaryl group.

As used herein, “anion” is any suitable anion known to one of ordinary skill in the art. Suitable anions include, but are not limited to, halide, sulfonate, carboxylate and phosphonate.

The antimicrobial composition may further comprise an antimicrobial agent. In some embodiments of the present invention, the polyurethane having a covalently bound antimicrobial moiety (“antimicrobial polyurethane”) may be soaked in a solution comprising at least one antimicrobial agent. In other embodiments, an additional antimicrobial agent can be added directly to the antimicrobial composition. Suitable antimicrobial agents include, but are not limited to, antimicrobial metals, metal salts, metal oxides and blends thereof. For example, metals such as silver, gold, tin, zinc, copper and iron (in any form) may be used. The metal (in whatever form) is then absorbed onto the antimicrobial polyurethane resulting in additional antimicrobial activity beyond the surface of the antimicrobial polyurethane. Without wishing to be bound by theory, it is believed that the “zone of inhibition” results from diffusion of the metal ions from the composition.

In another embodiment, the invention provides a coating comprising an antimicrobial polyurethane. The antimicrobial polyurethanes according to the invention may be applied to a surface and then cured to form a coating. Coating thickness may be from about 10 nm to about 200 mm The antimicrobial polyurethanes may be applied to the surface by methods known in the art including, but not limited to, drawdown, casting, brush, roller, and spray methods. In some embodiments, the antimicrobial polyurethane may be applied in the form of a composition.

The antimicrobial composition may comprise about 2% to about 95%, suitably about 5% to about 90% by weight of the antimicrobial polyurethane. The antimicrobial composition may include additional components or additives. Additives may include, but are not limited to, abrasion-resistance improvers, adhesion promoters, anti-blocking agents, anti-cratering agents, anti-crawling agents, anti-float agents, anti-flooding agents, anti-foaming agent, anti-livering agent, anti-marring agent, antioxidants, block resistant additive, brighteners, burnish-resistant additives, catalysts, corrosion-inihibitors, craze-resistance additive, deaerators, defoamers, dispersing agent, matting agents, flocculants, flow and leveling agents, gloss improvers, hammer-finish additives, hindered amine light stabilizers, intumescent additives, luminescent additives, mar-resistance additives, masking agents, rheology modifiers, slip-aids, spreading agents, static preventative, surface modifiers, tackifiers, texturizing agents, thixotropes, tribo-charging additive, UV absorbers, waxes, wet edge extenders, and wetting agents. The antimicrobial composition may contain less than about 60%, less than about 50%, less than about 40%, less than about 30%, less than about 20%, less than about 10%, less than about 5%, or less than about 2% by weight of additive. Suitably, an additive may be less than about 5% by weight of the composition.

In another embodiment, the invention provides a method of making an antimicrobial polyurethane. The antimicrobial polyurethanes according to the invention may be synthesized according to processes known in the art. As detailed in Examples 1 and 4, the polyols according to the invention may be synthesized in a radical polymerization step, followed by reacting hydroxyl groups with multifunctional isocyanates to form a cross-linked antimicrobial polyurethane. In some embodiments, the antimicrobial polyurethane is synthesized in the presence of a catalyst.

In another embodiment, the invention provides a method of reducing formation of a biofilm on a surface. In another embodiment, the invention provides a method of reducing microbial growth on a surface. Microbes include, but are not limited to, diatoms, algae, fungi, bacteria, parasites, protozoans, archaea, protests, amoeba, and other microorganisms. Biofilms include, but are not limited to, proteins, DNA, and polysaccharides produced by the microorganisms, and cells of the microorganisms themselves. Suitably, antimicrobial polyurethanes of the present invention reduce the growth of Staphylococcus epidermidis, Escherichia coli, Cellulophaga lytica, Navicula incerta, Halomonas pacifica, Pseudoalteromonas atlantica, Cobetia marina, Candida albicans, Clostridium difficile, Listeria monocytogenes, Staphylococcus aureus, Streptococcus faecalis, Bacillus subtilis, Salmonella chloraesius, Salmonella typhosa, Mycobacterium tuberculosis, Pseudomonas aeruginosa, Aerobacter aerogenes, Saccharomyces cerevisiae, Aspergillus niger, Aspergillus flares, Aspergillus terreus, Aspergillus verrucaria, Aureobasidium pullulans, Chaetomium globosum, Penicillum funiculosum, Trichophyton interdigital, Pullularia pullulans, Trichoderm sp. madison P-42, Cephaldascus fragans; Chrysophyta, Oscillatoria borneti, Anabaena cylindrical, Selenastrum gracile, Pleurococcus sp., Gonium sp., Volvox sp., Klebsiella pneumoniae, Pseudomonas fluorescens, Proteus mirabilis, Enterobacteriaceae, Acinetobacter spp., Pseudomonas spp., Candida spp., Candida tropicalis, Streptococcus salivarius, Rothia dentocariosa, Micrococcus luteus, Sarcina lutea, Salmonella typhimurium, Serratia marcescens, Candida utilis, Hansenula anomala, Kluyveromyces marxianus, Listeria monocytogenes, Serratia liquefasciens, Micrococcus lysodeikticus, Alicyclobacillus acidoterrestris, MRSA, Bacillus megaterium, Desulfovibrio sulfuricans, Streptococcus mutans, Cobetia marina, Enterobacter aerogenes, Enterobacter cloacae, Proteus vulgaris, Proteus mirabilis, Lactobacillus plantarum, Halomonas pacifica, and Ulva linza.

Reduction in microbial growth of an antimicrobial moiety may be determined by any method known in the art, including by calculating the minimal inhibitory concentration (MIC). MIC is the lowest concentration of an antimicrobial that will inhibit the visible growth of a microorganism after overnight incubation, as shown in Example 6. Antimicrobial activity of antimicrobial compositions may be determined by any method known in the art, including as described in Examples 3 and 8.

The method of reducing microbial growth on a surface or reducing formation of a biofilm may comprise applying to the surface an antimicrobial polyurethane or composition according to the invention as described above. The surface may be a marine surface. Marine surfaces include, but are not limited to, boat or ship hulls, anchors, docks, jetties, sewage pipes and drains, fountains, water-holding containers or tanks, and any surface in contact with a freshwater or saltwater environment. The surface may be a medical surface. Medical surfaces include, but are not limited to, implants, medical devices, examination tables, instrument surfaces, knobs, handles, rails, poles, countertops, sinks, and faucets Implants and medical devices may include, but are not limited to, prosthetic heart valves, urinary catheters, venous catheters, endotracheal tubes, and orthopedic implants. The surface may also be a household surface. Household surfaces include, but are not limited to, countertops, sink surfaces, cupboard surfaces, shelf surfaces, knobs, handles, rails, poles, countertops, sinks, and faucets. In some embodiments, the composition may be a paint, such as a marine paint. In another embodiment, the invention provides a medical device comprising an antimicrobial composition.

Antimicrobial polyurethanes or compositions according to the invention, may impart antimicrobial properties via a contact-active mechanism. Antimicrobial polyurethanes or compositions according to the invention may impart antimicrobial properties via a non-leaching (environmentally-friendly) mechanism, that is, they may suitably essentially leach no toxic components. Antimicrobial polyurethanes or compositions according to the invention may provide permanent antimicrobial activity at least due in part to leaching essentially no antimicrobial or biocidal components. As described in Example 7 and previously described in (Majumdar, P., et al., Biofouling, 2008. 24(3): 185-200), a leachate toxicity assay may be used to determine whether and how much a composition leaches components. In some embodiments, leachates from compositions according to the present invention may reduce biofilm or microbial growth by less than about 30%, less than about 25%, less than about 20%, less than about 15%, less than about 10%, less than about 5%, or less than about 2%, compared to a control.

Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

### EXAMPLES

Exemplary embodiments of the present invention are provided in the following examples. These examples are presented to illustrate the present antimicrobial polymer compositions and to assist one of ordinary skill in making and using the same. The examples are not intended in any way to otherwise limit the scope of the invention.

### Example 1

### Synthesis of Triclosan Acrylate Monomer

To a 500 mL two-neck round bottom flask with a stir magnet was added 30.0 g triclosan (0.1036 mol 5-chloro-2-(2,4-dichlorophenoxy)phenol, purchased from Alfa Aesar, Ward Hill, Mass.), 12.6 mL acryloyl chloride (0.1036 mol, from Sigma-Aldrich, St. Louis, Mo.), and 300 mL tetrahydrofuran (from VWR, West Chester, Pa.). The mixture was stirred until dissolved, then cooled to 0° C. at which time 21.7 mL triethylamine (0.1036 mol, from Sigma-Aldrich, St. Louis, Mo.) was added dropwise via a 125 mL addition funnel over 30 minutes. The reaction was allowed to equilibrate to room temperature over 16 hours. Solvent was removed under reduced pressure, and the solid mixture was purified by solvent extraction in hexane (from VWR, West Chester, Pa.) with water washes. After three washes with water, the hexane fraction was dried with magnesium sulfate and passed through a basic alumina column. Triclosan acrylate product was recrystallized from hexane and characterized by nuclear magnetic resonance spectroscopy (NMR). ¹H-NMR (CDCl₃, 400 MHz): 5.97 (dd, 1H), 6.21 (dd, 1H), 6.50 (dd, 1H), 6.87 (t, 2H), 7.16 (m, 2H), 7.24 (d, 1H), 7.41 (d, 1H). ¹³C-NMR: 163.36 (C═O); 151.13, 146.82, and 141.66 (Ar—O); 133.63 (CH═CH₂); 130.46, 128.22, 126.85, 124.55, 120.51, and 120.38 (Ar—H); 129.58, 129.36, and 126.05 (Ar—Cl); 127.15 (CH═CH₂). Carbon peak assignments were made based on DEPT135 and HMQC 2D-NMR spectra.

### Example 2

### Synthesis of Acrylic Polyols

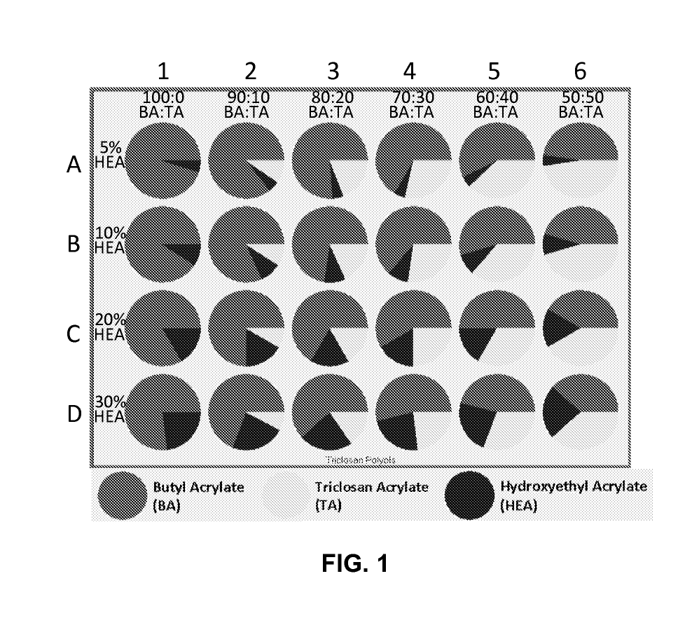

An array of acrylic polymers containing hydroxyethyl acrylate (HEA, from Sigma-Aldrich, St. Louis, Mo.), butyl acrylate (BA, from Sigma-Aldrich, St. Louis, Mo.), and triclosan acrylate (TA) was synthesized using conventional free radical solution polymerization in a Symyx Batch Reactor System®. The Symyx Batch Reactor System® is a fully automated system, composed of a Cavro® dual-arm liquid handling robot housed in an inert atmosphere glove box. Using information from the experimental designs created with Library Studio®, a protocol for the experimental design created in Symyx Library Studio® was executed. The robot automatically dispensed varying amounts of BA, HEA, and a 50% w/w solution of TA in toluene into a 4×6 array of 8 mL glass vials, stirred them using magnetic stirring, and heated them at 95° C. for 10 hours. HEA content was varied sequentially by row while TA and BA content were varied sequentially by column from zero TA in column 1 to a 50:50 molar mixture of TA and BA in column 6. Monomer addition was followed by the addition of toluene to create 50% by weight monomer solutions which was followed by the addition of a 10% weight percent solution of Vazo 67 (2,2′-azobisvaleronitrile free radical initiator, from DuPont, Wilmington, Del.) in toluene. FIG. 1 and Table 1 provide the composition of each polymerization mixture generated. In FIG. 1, rows A-D vary with respect to HEA content while columns 1-6 vary with respect to TA content. After the addition of the free radical initiator, the vials were sealed, stirring was initiated, and the reaction mixtures were heated at 95° C. for 10 hours.

TABLE 1
Compositions of reaction mixtures used to produce acrylic polyols.

| | Triclosan | Butyl | | | |
|---|---|---|---|---|---|
| Polyol | Acrylate | Acrylate | Hydroxyethyl | Toluene | Vazo 67 |
| Formulation | (mg) | (mg) | Acrylate (mg) | (mg) | (mg) |
| A1 | 0 | 2870 | 130 | 3000 | 10 |
| A2 | 660 | 2230 | 110 | 3000 | 10 |
| A3 | 1160 | 1740 | 100 | 3000 | 10 |
| A4 | 1560 | 1350 | 90 | 3000 | 10 |
| A5 | 1870 | 1050 | 80 | 3000 | 10 |
| A6 | 2130 | 800 | 70 | 3000 | 10 |
| B1 | 0 | 2750 | 250 | 3000 | 10 |
| B2 | 640 | 2140 | 220 | 3000 | 10 |
| B3 | 1130 | 1680 | 190 | 3000 | 10 |
| B4 | 1510 | 1320 | 170 | 3000 | 10 |
| B5 | 1830 | 1020 | 150 | 3000 | 10 |
| B6 | 2080 | 780 | 140 | 3000 | 10 |
| C1 | 0 | 2540 | 460 | 3000 | 10 |
| C2 | 600 | 2000 | 400 | 3000 | 10 |
| C3 | 1060 | 1580 | 360 | 3000 | 10 |
| C4 | 1430 | 1250 | 320 | 3000 | 10 |
| C5 | 1740 | 970 | 290 | 3000 | 10 |
| C6 | 1990 | 740 | 270 | 3000 | 10 |
| D1 | 0 | 2360 | 640 | 3000 | 10 |
| D2 | 560 | 1870 | 570 | 3000 | 10 |
| D3 | 1000 | 1490 | 510 | 3000 | 10 |
| D4 | 1360 | 1180 | 460 | 3000 | 10 |
| D5 | 1650 | 930 | 420 | 3000 | 10 |
| D6 | 1900 | 710 | 390 | 3000 | 10 |

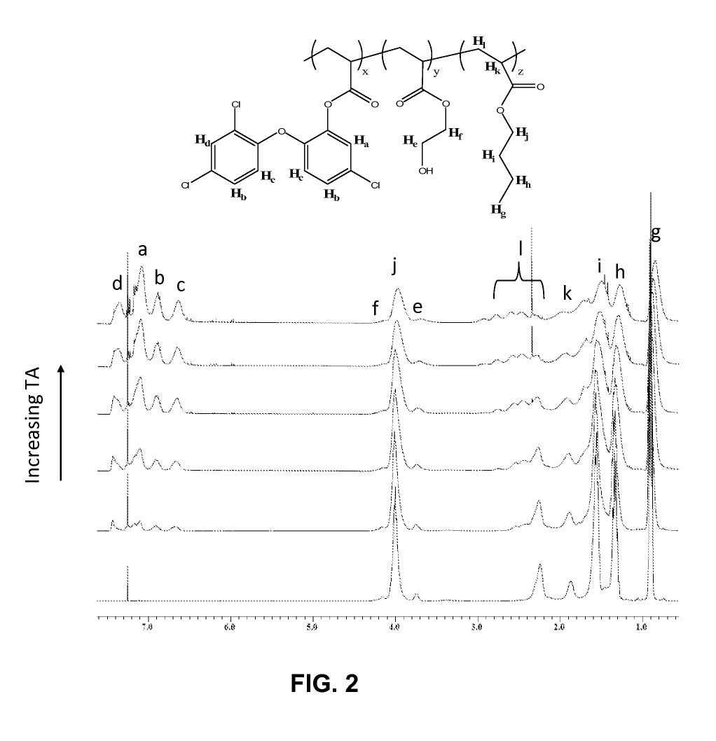

The resulting polymer array was characterized using nuclear magnetic spectroscopy (NMR). NMR spectra were obtained with a JEOL 400 MHz ECA400 spectrometer equipped with a 24 position autosampler. Spectral analysis was facilitated using Delta software for ¹³C and ¹H spectra. Distortionless Enhancement by Polarization Transfer (DEPT) and Heteronuclear Multiple-Quantum Coherence (HMQC), a two-dimensional technique, were also used to assist in the assignment of ¹³C peaks. NMR was used to verify that TA repeat units were effectively incorporated into the polyols and to verify that residual monomer was removed from the polymer samples. ¹H NMR spectra obtained for polymer samples corresponding to the first row of the design (5% HEA-containing acrylic polyols, A1-A6) are shown in FIG. 2. The NMR spectra displayed in FIG. 2 showed that the intensity of the aromatic proton peaks increased with increasing TA monomer level while the intensity of the BA-based proton peaks decreased. The lack of vinyl proton peaks in the region of 5.75-6.52 ppm indicated effective removal of residual monomer from the samples. The spectra also showed residual solvent peaks associated with chloroform (7.26 ppm) and toluene (2.36, 7.17, and 7.25 ppm).

The resulting polymer array was also characterized using gel permeation chromatography (GPC) to determine molecular weight and molecular weight distribution data for the acrylic polyols. Polymer molecular weight data was obtained using a Symyx RapidGPC®, which consisted of a dual-arm liquid handling robot coupled to a temperature-adjustable GPC system using an evaporative light scattering detector (Polymer Laboratories ELS 1000) and 2XPLge1 Mixed-B columns (10 μm particle size). THF was used as the eluent at a flow rate of 2.0 mL/min, and molecular weights were determined using the aforementioned column and detector at 45° C. by comparing to polystyrene standards. Relatively high yield was obtained for all of the polymerizations indicating good copolymerizability between the three different monomers and the use of an adequate polymerization time. Specifically, polymer yield was about 80-100%. Number average molecular weight (Mn) decreased with increasing TA concentration.

The resulting polymer array was also characterized using differential scanning calorimetry (DSC). A DSC Q1000 from TA Instruments equipped with a 50 place autosampler was used for determining the Tg of the acrylic polyols. Samples (5-10 mg each) were placed in aluminum pans and subjected to a heat-cool-heat cycle spanning −90° C. to 150° C. using a heating and cooling rate of 10° C. min⁻¹. Tgs measured using the second heating cycle were reported. Tg of the acrylic polyols was found to increase with increasing TA content. The increase in Tg with increasing TA content was consistent with expectations considering the larger size and higher rigidity of the triclosan ester pendant group as compared to either the hydroxyethyl ester or butyl ester pendant group of HEA and BA, respectively. Larger, more rigid pendant groups restricted polymer chain backbone mobility resulting in relatively high Tgs.

Polymer yield was determined gravimetrically. A Bohdan Automated Balance was used to facilitate high-throughput measurements of polymer yield. The automated balance allowed for rapid, fully automated weighing of the 8 mL vials used for the acrylic polyol reaction vessels. The instrument consisted of an automated arm which transported vials to and from a 4-decimal balance and recorded the weights to a centralized database. A GeneVac EZ-2 Centrifuge Evaporator® was used as a parallel evaporation system to also measure polymer yield. The system, which consisted of a centrifuge that could be heated and evacuated, was used for the parallel removal of solvents and residual monomer from the array of 8 mL vials used as the polymerization reactors. The protocol used for the parallel evaporation involved heating at 80° C. and 1 mbar of pressure for 174 minutes.

### Example 3

### Determination of Antimicrobial Activity of Polyols in Solution

Three microorganisms associated with infection and failure of implanted medical devices, Staphylococcus epidermidis (35984, Gram-positive bacterium), Escherichia coli (12435, Gram-negative bacterium), and Candida albicans (opportunistic fungal pathogen), were utilized to evaluate the antimicrobial activity of biocide functional polyols, described in Example 2, in solution. A 100 μg/mL concentration of each biocide functional polyol was prepared in TSB (bacteria) and RPMI (C. albicans) medium. 0.5 mL of a 1:1000 dilution of an overnight culture in TSB or RPMI was added to 0.5 mL of the 100 μg/mL concentration of each biocide functional polyol to achieve a final concentration of 50 μg/mL. A test tube of TSB and RPMI, without a biocide functional polyol, served as a positive growth control. Test tubes were vortexed for 10 seconds before three 0.2 mL aliquots were dispensed into a 96-well plate. Plates were incubated statically (24 hrs, 37° C.) and then measured for absorbance at 600 nm. A positive antimicrobial effect was reported for each biocide functional polyol that completely inhibited microbial growth in solution (i.e., an absorbance value comparable to blank medium without the addition of the microorganism). Results are shown in Table 2.

TABLE 2
Antimicrobial activity of polyols containing triclosan moieties.

| | Polymer | | | Antimicrobial |
|---|---|---|---|---|
| | Yield | | | Activity in solution |
| Sample ID | (%) | Mn (g/mol) | Tg (° C.) | at 50 ug/mL* |
| Polyol A1 | 85.63 | 27670 | −43.93 | None |
| Polyol A2 | 86.44 | 22764 | −24.70 | None |
| Polyol A3 | 89.03 | 20592 | −7.90 | None |
| Polyol A4 | 88.49 | 16787 | 9.61 | None |
| Polyol A5 | 88.12 | 17922 | 22.84 | None |
| Polyol A6 | 93.35 | 15367 | 30.47 | None |
| Polyol B1 | 85.77 | 24996 | −41.26 | None |
| Polyol B2 | 86.04 | 21878 | −22.08 | None |
| Polyol B3 | 87.47 | 20569 | −4.76 | None |
| Polyol B4 | 88.66 | 16803 | 8.03 | None |
| Polyol B5 | 90.41 | 15780 | 20.40 | None |
| Polyol B6 | 90.87 | 15277 | 28.50 | None |
| Polyol C1 | 87.19 | 24591 | −37.09 | None |
| Polyol C2 | 86.87 | 23273 | −17.91 | None |
| Polyol C3 | 88.21 | 19519 | −3.01 | None |
| Polyol C4 | 89.85 | 17956 | 11.19 | None |
| Polyol C5 | 91.65 | 15961 | 22.74 | None |
| Polyol C6 | 91.55 | 12164 | 26.77 | None |
| Polyol D1 | 89.42 | 22993 | −34.13 | None |
| Polyol D2 | 84.91 | 20116 | −15.55 | None |
| Polyol D3 | 85.53 | 21798 | −2.16 | None |
| Polyol D4 | 87.01 | 16313 | 9.50 | None |
| Polyol D5 | 91.20 | 16336 | 22.51 | None |
| Polyol D6 | 92.96 | 14226 | 28.17 | None |

*solution tested against Escherichia coli, Staphylococcus epidermidis and Candida albicans

### Example 4

### Polyurethane Composition Preparation

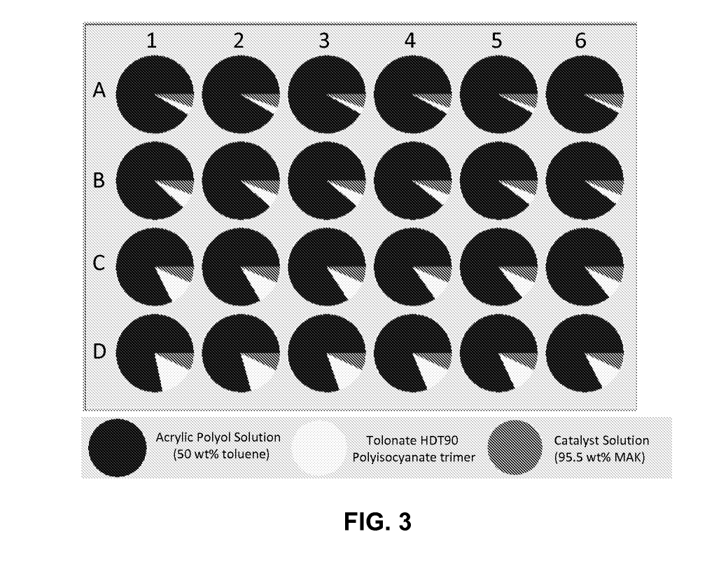

An array of polyurethane compositions were produced using a Symyx coating formulation system. The formulation system consisted of a dual-arm Cavro® liquid handling robot which took formulation instructions from Library Studio® to prepare solution blends contained within 8 mL glass vials. Dispensing was conducted using disposable pipette tips and stirring was accomplished using magnetic stiffing. The polyurethane compositions were produced by solution blending the acrylic polyols described in Example 3, hexamethylene diisocyanate trimer solution (Tolonate HDT90 from Rhodia, Cranbury, N.J.), and MAK solution is DABCO-K15. Polyurethane grade MAK (2-heptanone) was purchased from Eastman Chemical (Kingsport, Tenn.), and DABCO-K15 (the tertiary amine-based polyurethane catalyst 1,4-diazobicyclo[2.2.2]octane) was purchased from Air Products (Allentown, Pa.). Table 3 lists and FIG. 3 illustrates the composition of each composition prepared. In FIG. 3, polyurethane composition labeling corresponds to acrylic polyol labeling (i.e., composition A1 was made using polyol A1, etc.). Compositions were designed with the aid of Library Studio® to enable the isocyanate to hydroxyl ratio for each composition solution to be kept constant at 1.1.

TABLE 3
Compositions of the polyurethane compositions. Labelling
corresponds to acrylic polyol labeling (i.e., composition A1
was made using polyol A1, etc.).

| | Acrylic Polyol Solution | Tolonate | Catalyst Solution |
|---|---|---|---|
| Coating | (50 wt % toluene) | HDT90 | (95.5 wt % MAK) |
| Formulation | (mg) | (mg) | (mg) |
| A1 | 4500 | 220 | 240 |
| A2 | 4500 | 220 | 240 |
| A3 | 4500 | 210 | 240 |
| A4 | 4500 | 210 | 240 |
| A5 | 4500 | 210 | 240 |
| A6 | 4500 | 210 | 240 |
| B1 | 4500 | 420 | 270 |
| B2 | 4500 | 410 | 270 |
| B3 | 4500 | 410 | 270 |
| B4 | 4500 | 400 | 270 |
| B5 | 4500 | 400 | 270 |
| B6 | 4500 | 400 | 270 |
| C1 | 4500 | 770 | 330 |
| C2 | 4500 | 760 | 330 |
| C3 | 4500 | 750 | 330 |
| C4 | 4500 | 750 | 320 |
| C5 | 4500 | 740 | 320 |
| C6 | 4500 | 730 | 320 |
| D1 | 4500 | 1070 | 380 |
| D2 | 4500 | 1060 | 380 |
| D3 | 4500 | 1050 | 370 |
| D4 | 4500 | 1040 | 370 |
| D5 | 4500 | 1030 | 370 |
| D6 | 4500 | 1020 | 370 |

Catalyst, DABCO-K15, was used at a concentration of 9 wt. % of a 0.5% (wt.) solution based on total coating solids. After allowing the solutions to stir briefly to insure homogenization, coatings were deposited onto substrates in various formats and allowed to air dry for 3 hours after which they were placed in an 80° C. oven for one hour to obtain full cure. Coatings were deposited onto three different substrate formats to enable high-throughput characterization using biological assays, parallel dynamic mechanical thermal analysis (pDMTA), and surface energy measurements. Coatings for biological assays were deposited into 24-well polystyrene plates modified with aluminum discs in the bottom of each well (described in Majumdar, P., et al. Biofouling, 2008. 24(3): 185-200; Stafslien, S. J., et al., Journal of Combinatorial Chemistry, 2006. 8(2): 156-162). The aluminum discs were primed with Intergard 264 (a commercial marine-grade epoxy primer, purchased from International Paint, Houston, Tex.) to ensure good adhesion of the coatings to the discs. Coatings for pDMTA were deposited onto a supported Kapton® film using a Symyx liquid handling robot developed specifically for the pDMTA system. For surface energy measurements, the coatings were deposited on 4″×8″ aluminum panels using a draw-down bar designed to produce a wet film thickness of 8 mL.

### Example 5

### Characterization of Polyurethane Composition Physical Properties

The glass transition temperature (Tg) of the polyurethane compositions described in Example 4 was determined using a Symyx Parallel Dynamic Mechanical Thermal Analysis (pDMTA) system. For this system, coating solutions were deposited on a supported Kapton® film using a liquid handling robot to generate an array of 96 coating droplets. The thickness of the droplets was measured using an automated thickness measurement device equipped with a laser profilometer. Finally, the array plate was attached to the pDMTA apparatus and the entire array oscillated over an array of 96 force probes generating 96 different DMTA thermograms. Prior to measuring thickness and viscoelastic properties, the array plate was placed in a 100° C. oven for 24 hours to eliminate any prior thermal history. The heating profile used for the experiment consisted of heating from −25° C. to 125° C. at 1° C. min⁻¹ using a frequency of 10 Hz. Tg was reported as the peak of the tan delta curve.

Standard deviations in Tg ranged from 0.0 to 4.2° C. Two distinct trends exist in the coating Tg data. First, at constant HEA content of the acrylic polyol, coating Tg increased with increasing TA content of the acrylic polyol. This trend was the same as the trend observed for the Tg of the acrylic polyols. The dependence of coating Tg on acrylic polyol TA content was quite dramatic. For example, increasing the acrylic polyol TA content from 0 mol % to 50 mol % for coatings derived from acrylic polyols containing 5 mol % HEA increased coating Tg by 71° C. The second general trend involved the effect of HEA content of the acrylic polyol on coating Tg. At a given acrylic polyol TA content, coating Tg increased with increasing acrylic polyol HEA content. Crosslink density and, thus, coating Tg increased with increasing acrylic polyol HEA content. Overall, increasing TA content and HEA content of the acrylic polyol increased coating Tg. Over the entire compositional space investigated, coating Tg spanned a wide range extending from −15° C. to 72° C.

Coating surface energetics and surface compositional stability are important for antimicrobial compositions designed to function through a contact-active mechanism. To investigate variations in surface chemistry, measurement of water contact angle, water contact angle hysteresis, and surface energy of the polyurethane composition described in Example 4 were made using Symyx surface energy measurement system, which is an automated, high-throughput measurement system. The system operated by dispensing 10 μL drops of liquid on the coating surface, capturing images of each droplet using a charge-coupled device (CCD) camera, and determining the contact angle using image analysis software. Surface energy data was obtained by measuring contact angles for both water and methylene iodide and calculating surface energy using the Owens-Wendt method (described in Owens, D. K. and R. C. Wendt, Journal of Applied Polymer Science, 1969. 13(8): 1741-7). In addition to static measurements, the system also ran a dynamic contact angle protocol for the measurement of water contact angle hysteresis. For water contact angle hysteresis, a 10 μL drop of water was placed on the coating surface and water was added at a constant rate of 0.1 μL sec⁻¹ and contact angle was measured at 10 second intervals for one minute. After one minute, water was removed at the same rate as it was added, and contact angle was again measured at 10 second intervals. Contact angle hysteresis was then calculated by averaging the first three advancing and the last three receding contact angles and subtracting the receding average from the advancing average. Water contact angle and surface energy were measured in triplicate. The standard deviations for the water contact angle ranged from 0.39° to 4.70° with most coatings being below 1.0° while the standard deviation for the surface energy ranged from 0.21 to 3.17 mN/m. Little variation in water contact and surface energy were observed between the various coatings. While no significant difference in static water contact angle was observed, a relatively wide variation in dynamic water contact angle was observed as indicated by the water contact angle hysteresis values.

Contact angle hysteresis is a general indicator of surface chemical and morphological stability and is known to be attributed to one of several effects such as surface roughness, chemical heterogeneity, surface deformation, surface configuration change, adsorption/desorption mechanisms, or some combination of these effects (described in Majumdar, P., et al., Journal of Coatings Technology and Research, 2007. 4(2): 131-138; Wang, J. H., et al., Langmuir, 1994. 10(10): 3887-97). In general, the hysteresis can be used as an indication of the degree of surface instability resulting from wetting of the surface. From the angle hysteresis data, there appeared to be a very general trend of increasing water contact hysteresis with increasing HEA content of the acrylic polyol.

### Example 6

### Antimicrobial Activity of Triclosan

The antimicrobial activity of triclosan toward the microorganisms of interest was determined by measuring the minimum inhibitor concentration (MIC). The protocol for determining the minimum inhibitory concentration (MIC) of antimicrobial agents in solution has been reported previously (described in Stafslien, S., et al., Biofouling, 2007. 23(1/2): 37-44.). Triclosan was serially diluted (2-fold) in marine broth, tryptic soy broth, and Guillard's F/2 medium for the MIC evaluation of C. lytica, S. epidermidis or E. coli, and N. incerta, respectively. The triclosan concentration range evaluated was from 0.2 μg/mL to 25 μg/mL.

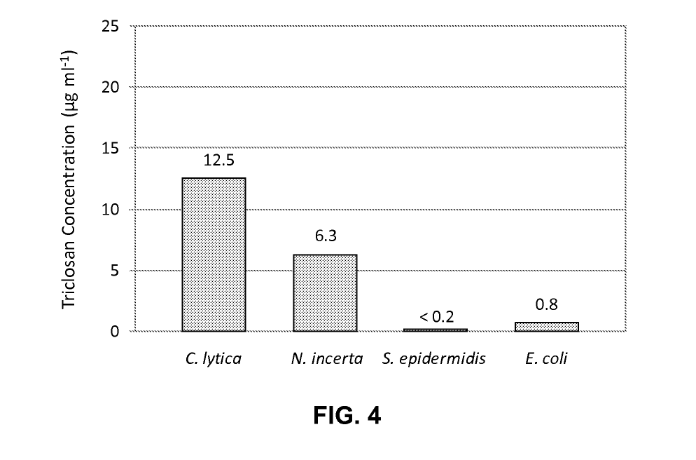

As shown in FIG. 4, the medically relevant bacteria, S. epidermidis and E. coli, were much more sensitive to triclosan than the marine microorganisms, C. lytica and N. incerta. S. epidermidis growth was completely inhibited at the lowest concentration of triclosan evaluated (0.2 μg/mL), while complete C. lytica growth inhibition was not observed until the concentration of triclosan reached 12.5 μg/mL.

### Example 7

### Toxicity Evaluation of Composition Leachates

The polyurethane compositions as described in Example 4 were examined to ensure that the compositions were not leaching toxic compounds. A leachate toxicity assay, which has been previously described in detail (Majumdar, P., et al., Biofouling, 2008. 24(3): 185-200), was used to verify that no toxic components were leaching from the coatings after the 14 days of water immersion. Coating arrays were immersed in a recirculating water bath of deionized water for 14 days to remove leachable residues from the coatings, such as catalyst, solvent, un-reacted monomers, etc. The preconditioned coatings were then incubated in 1 mL of growth medium for 24 hrs and the resultant coating leachates collected. Then 0.05 mL of the appropriate bacterial suspension (C. lytica, E. coli or S. epidermidis) in biofilm growth medium (BGM) (˜10⁸ cells/mL), 0.05 mL of C. albicans in RPMI medium, or 0.05 mL of a N. incerta suspension in Guillard's F/2 medium (˜10⁵ cells/mL) was added to 1 mL of coating leachate and 0.2 mL of the coating leachate with the added microorganism was transferred in triplicate to a 96-well array plate. The coating array plates were incubated for 24 hrs at 28° C. (C. lytica) and 37° C. (E. coli and S. epidermidis) for the bacteria, 24 hrs at 37° C. for C. albicans, and 48 hrs at 18° C. in an illuminated growth cabinet with a 16:8 light:dark cycle (photon flux density 33 μmol m⁻² s⁻¹) for N. incerta. The coating array plates containing the bacteria and fungi were rinsed three times with deionized water and the retained biofilms stained with 0.5 mL of crystal violet dye. After this 0.5 mL of glacial acetic acid was added to each coating well to extract the crystal violet dye and absorbance measurements were made at 600 nm with a multi-well plate reader. N. incerta-containing array plates were characterized by extracting biofilms with DMSO and quantifying chlorophyll concentration using fluorescence spectroscopy (excitation: 360 nm; emission: 670 nm). A reduction in the amount of bacterial/fungal biofilm retention or algal growth compared with a positive growth control (i.e., organism in fresh growth media) was considered to be a consequence of toxic components being leached from the coating into the overlying medium.

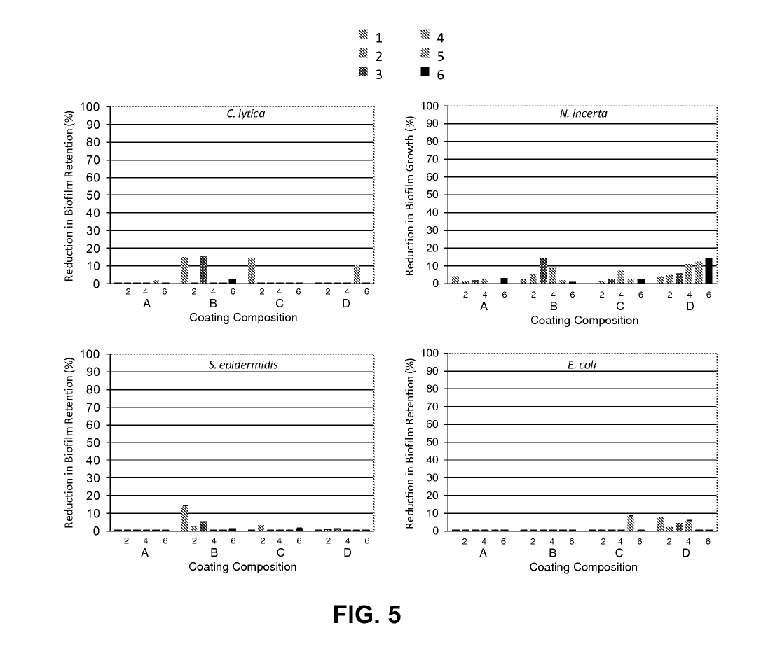

FIG. 5 displays results obtained using the leachate toxicity assay. In FIG. 5, sample labeling corresponds to the same labeling described in FIG. 3. Each data point represents the percent reduction in biofilm growth or retention compared to a positive growth control (organism plus fresh growth medium). Error bars represent one standard deviation of the mean value of three replicate measurements. The results shown in FIG. 5 indicated that none of the coating leachates showed any substantial toxicity, ≧20% reduction in biofilm retention/growth, for any of the four microorganisms S. epidermidis, E. coli, C. lytica, and N. incerta.

### Example 8

### Characterization of Polyurethane Composition Biological Properties

Biofilm growth and retention assays were conducted to determine the antimicrobial activity of the compositions described in Example 4. A high-throughput bacterial/fungal biofilm retention and an algal biofilm growth assay was utilized to rapidly assess the antimicrobial activity of coatings prepared in array plates. Bacterial/fungal biofilm retention was quantified using a crystal violet colorimetric assay (Stafslien, S. J., et al., Journal of Combinatorial Chemistry, 2006. 8(2): 156-162), while algal biofilm growth was determined by measuring fluorescence of chlorophyll extracted from the biofilm (Casse, F., et al., Biofouling, 2007. 23(1/2): 121-130). A Tecan® EVO Freedom 200 liquid handling robot was used for screening the antimicrobial properties of the coatings toward a range of microorganisms. The deck of the EVO Freedom 200 was modified with a custom built plate holder to accommodate coating libraries prepared in 24-well array plates. The custom built plate holder included a pressurized clamping system to properly apply crystal violet extraction templates (Stafslien, S. J., et al., Journal of Combinatorial Chemistry, 2006. 8(2): 156-162) to the array plates.

Three microorganisms associated with infection and failure of implanted medical devices, Saphylococcus epidermidis (Gram-positive bacterium), Escherichia coli (Gram-negative bacterium) and Candida albicans (opportunistic fungal pathogen), and two marine fouling microorganisms, Cellulophaga lytica (Gram-negative bacterium) and Navicula incerta (diatom algae), were utilized to ascertain the broad spectrum antimicrobial activity of the coating surfaces. The experimental conditions employed to achieve optimal biofilm growth with the marine fouling microorganisms has been reported previously (Majumdar, P., et al., Biofouling, 2008. 24(3): 185-200.). S. epidermidis and E. coli were re-suspended to a final cell density of 10⁸ cells ml⁻¹ in tryptic soy broth supplemented with 2.5% dextrose (TSBD) and minimal medium M63 (M63), respectively, and incubated at 37° C. for 24 hours.

The procedure used for conducting the bacterial and fungal biofilm retention assays is as follows: Array plates were inoculated with a 1 mL suspension of the appropriate bacterium/fungi in BGM (˜10⁸ cells/mL). The plates were then incubated statically in a 28° C. incubator for 24 hrs to facilitate cell attachment and subsequent colonization. The plates were then rinsed three times with 1 mL of deionized water to remove any planktonic or loosely attached biofilm. The biofilm retained on each coating surface after rinsing was then stained with crystal violet. Once dry, the crystal violet dye was extracted from the biofilm with the addition of 0.5 mL of glacial acetic acid and the resulting eluate was measured for absorbance at 600 nm. The absorbance values obtained were directly proportional to the amount of biofilm retained on the coating surface. Each data point represented the mean absorbance value of three replicate samples and was reported as a relative reduction compared with a control coating.

The evaluation of diatom biofilm growth was carried out as follows: 1.0 mL of N. incerta, re-suspended to ˜10⁵ cells/mL in ASW in Guillard's F/2 medium, was delivered to each coating sample well. Plates were incubated statically for 48 hrs at 18° C. in an illuminated growth cabinet with a 16:8 light:dark cycle (photon flux density 33 μmol m⁻² s⁻¹). The coating array plates were then quantified for biofilm growth by extracting with DMSO and measuring the chlorophyll concentration using fluorescence spectroscopy (excitation: 360 nm; emission: 670 nm). The fluorescence values obtained were directly proportional to the amount of biofilm growth obtained on the coating surface. Each data point represented the mean fluorescence value of three replicate samples and was reported as a relative reduction compared with a control coating. Results were compared to percent reduction in biofilm on a silicone elastomer coating (DC3140 from Dow Corning, Midland, Mi.).

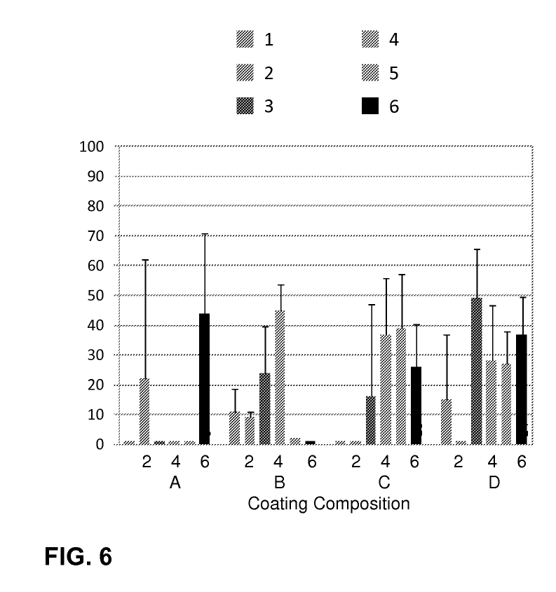

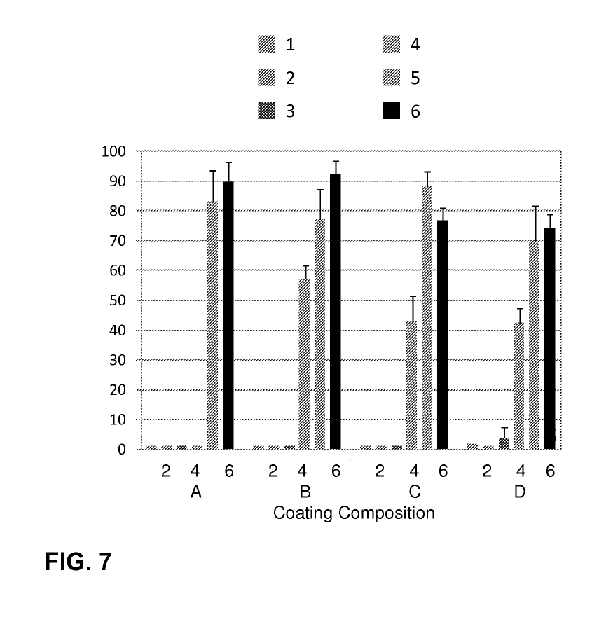

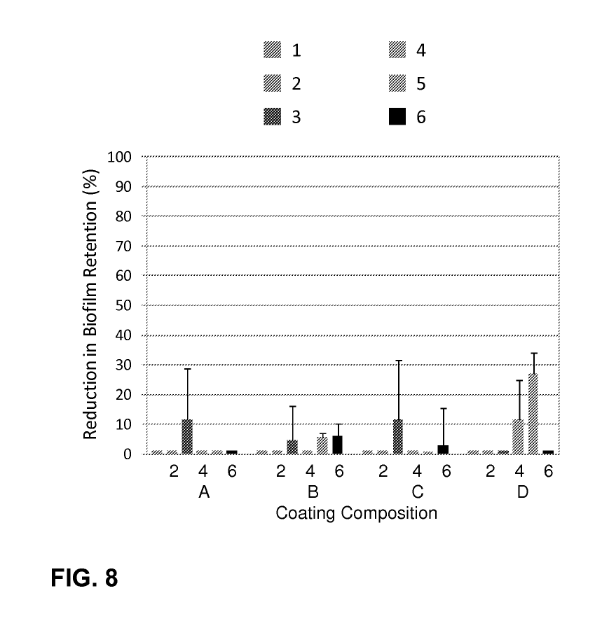

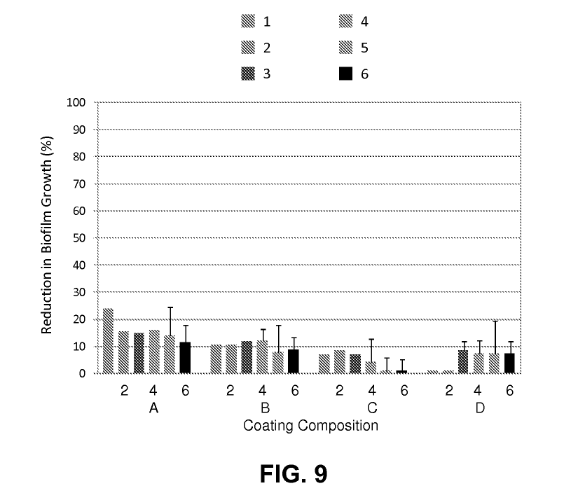

FIGS. 6, 7, and 8 display reduction in biofilm retention data for the three bacterial species, C. lytica, S. epidermidis, and E. coli, respectively. In FIGS. 6, 7, and 8, sample labeling corresponds to the sample labeling described in FIG. 3. Each data point represents the percent reduction in biofilm growth compared to the silicone elastomer control coating, and error bars represent one standard deviation of the mean value of three replicate measurement. Images of coating array plates after crystal violet staining were also examined. Observation of the coating array plate images enabled a quick visual assessment of antimicrobial activity since the stained biofilms were brightly colored. The results shown in FIGS. 6, 7, and 8 showed that a substantial antimicrobial effect was obtained for S. epidermidis while minimal or no antimicrobial effect was observed for C. lytica or E. coli. In general, S. epidermidis biofilm retention decreased as the amount of TA acrylate in the acrylic polyol increased. The largest reduction in S. epidermidis biofilm retention (≧90%) was obtained for coating compositions derived from acrylic polyols produced using 5 or 10% HEA and the highest level of TA (compositions A6 and B6). Results obtained with the diatom algae biofilm growth assay are shown in FIG. 9. In FIG. 9, sample labeling corresponds to the sample labeling described in FIG. 3. Each data point represents the percent reduction in biofilm growth compared to the silicone elastomer control coating, and error bars represent one standard deviation of the mean value of three replicate measurements. Similar to the results with E. coli and C. lytica, no substantial antimicrobial effect was observed with N. incerta. Results are also shown in Table 4.

TABLE 4
Antimicrobial activity of polyurethane coatings based on polyols containing triclosan moieties.

| | | Water Contact | Water Contact | Reduction in | Reduction in | Reduction in | Reduction in |
|---|---|---|---|---|---|---|---|
| Sample | Tg | Angle | Angle | Biofilm Growth | Biofilm Growth | Biofilm Growth | Biofilm Growth |
| ID | (° C.) | (°) | Hysteresis | for C. lytica | for N. incerta | for E. coli | for S. epidermidis |
| Coating A1 | −15.1 | 96.16 | 15.4 | 0.0% | 26.5% | 0.0% | 0.0% |
| Coating A2 | −3.5 | 101.99 | 10.7 | 21.9% | 21.6% | 0.0% | 1.0% |
| Coating A3 | 15.8 | 98.46 | 8.2 | 0.0% | 14.4% | 12.0% | 0.0% |
| Coating A4 | 30.8 | 90.62 | 10.7 | 0.0% | 7.6% | 0.0% | 0.0% |
| Coating A5 | 42.2 | 89.89 | 6.4 | 0.0% | 14.8% | 0.0% | 83.0% |
| Coating A6 | 55.6 | 92.71 | 9.0 | 44.1% | 12.0% | 0.0% | 90.0% |
| Coating B1 | −8.3 | 96.09 | 14.0 | 10.6% | 18.9% | 0.0% | 0.0% |
| Coating B2 | 6.3 | 97.05 | 13.4 | 8.6% | 15.7% | 0.0% | 0.0% |
| Coating B3 | 23.6 | 93.56 | 10.4 | 24.0% | 17.8% | 5.0% | 0.0% |
| Coating B4 | 34.2 | 91.08 | 11.3 | 45.1% | 17.8% | 0.0% | 57.0% |
| Coating B5 | 47.0 | 90.36 | 7.6 | 1.7% | 4.9% | 6.0% | 77.0% |
| Coating B6 | 57.5 | 89.41 | 11.5 | 0.0% | 8.2% | 6.0% | 92.0% |
| Coating C1 | 5.1 | 93.50 | 18.8 | 0.0% | 10.2% | 0.0% | 0.0% |
| Coating C2 | 22.5 | 95.51 | 12.7 | 0.0% | 12.6% | 0.0% | 0.0% |
| Coating C3 | 35.9 | 94.71 | 12.1 | 16.1% | 8.6% | 12.0% | 0.0% |
| Coating C4 | 46.0 | 87.27 | 3.0 | 36.8% | 0.0% | 0.0% | 43.0% |
| Coating C5 | 56.3 | 92.67 | 12.2 | 38.7% | 0.0% | 1.0% | 89.0% |
| Coating C6 | 61.7 | 91.74 | 5.0 | 25.9% | 0.0% | 3.0% | 77.0% |
| Coating D1 | 20.7 | 94.68 | 15.4 | 14.7% | 2.0% | 0.0% | 2.0% |
| Coating D2 | 34.6 | 93.40 | 16.0 | 0.0% | 0.5% | 0.0% | 0.0% |
| Coating D3 | 45.3 | 92.82 | 18.2 | 49.2% | 3.9% | 0.0% | 4.0% |
| Coating D4 | 53.8 | 88.88 | 13.8 | 28.2% | 0.0% | 12.0% | 43.0% |
| Coating D5 | 61.5 | 90.01 | 17.0 | 26.6% | 0.0% | 27.0% | 70.0% |
| Coating D6 | 72.1 | 94.55 | 13.9 | 37.1% | 2.1% | 0.0% | 74.0% |

### Example 9

### Preparation and Characterization of Polyurethane Compositions with Silver Nitrate

Acrylic polyols containing QAS moieties were synthesized according to the procedure described in Example 2. An additional quaternization step was carried out after polymerization complete by adding an alkyl halide and heating the composition at 80° C. for 32 hours with magnetic stirring. The antimicrobial activity of the acrylic polyols containing QAS moieties was tested as described in Example 3. Results are shown in Table 5.

TABLE 5
Antimicrobial activity of polyols containing triclosan moieties.

| | Polymer | | | Antimicrobial |
|---|---|---|---|---|
| | Yield | | | Activity in solution |
| Sample ID | (%) | Mn (g/mol) | Tg (° C.) | at 50 ug/mL* |
| Polyol A1 | 89.19 | 35119 | −46.74 | None |
| Polyol A2 | 89.47 | 13391 | −47.44 | None |
| Polyol A3 | 84.18 | 7525 | −48.53 | None |
| Polyol A4 | 81.30 | 5052 | −49.94 | None |
| Polyol A5 | 77.92 | 3531 | −51.91 | C. albicans |
| Polyol A6 | 73.70 | 2539 | −57.58 | C. albicans, E. coli |
| Polyol B1 | 91.22 | 34057 | −44.36 | None |
| Polyol B2 | 88.48 | 13151 | −43.89 | None |
| Polyol B3 | 84.63 | 7783 | −44.88 | None |
| Polyol B4 | 81.75 | 5570 | −45.96 | None |
| Polyol B5 | 77.96 | 3655 | −46.47 | C. albicans |
| Polyol B6 | 73.45 | 2540 | −49.38 | C. albicans, E. coli |
| Polyol C1 | 92.01 | 35087 | −39.53 | None |
| Polyol C2 | 88.85 | 12718 | −38.44 | None |
| Polyol C3 | 84.56 | 8284 | −41.19 | None |
| Polyol C4 | 81.68 | 5861 | −40.58 | None |
| Polyol C5 | 71.53 | 3719 | −40.51 | C. albicans |
| Polyol C6 | 71.97 | 2619 | −41.04 | C. albicans, E. coli |
| Polyol D1 | 96.51 | 32079 | −36.58 | None |
| Polyol D2 | 81.87 | 12503 | −37.61 | None |
| Polyol D3 | 85.13 | 8181 | −36.65 | None |
| Polyol D4 | 80.98 | 5736 | −39.45 | None |
| Polyol D5 | 75.96 | 3906 | −40.52 | C. albicans |
| Polyol D6 | 71.93 | 2772 | −40.64 | C. albicans, E. coli |

*solution tested against Escherichia coli, Staphylococcus epidermidis and Candida albicans

Two polyurethane compositions were synthesized from the acrylic polyols containing QAS moieties, according to the procedure described in Example 4. The antimicrobial activity of the polyurethane compositions from acrylic polyols containing QAS moieties was tested as described in Example 8. Results are shown in Table 6.

TABLE 6
Antimicrobial activity of polyurethane compositions synthesized from polyols containing QAS moieties.

| | | Water Contact | Water Contact | Reduction in | Reduction in | Reduction in | Reduction in | Reduction in |
|---|---|---|---|---|---|---|---|---|
| Sample | Tg | Angle | Angle | Biofilm Growth | Biofilm Growth | Biofilm Growth | Biofilm Growth | Biofilm Growth |
| ID | (° C.) | (°) | Hysteresis | for N. incerta | for C. lytica | for E. coli | for S. epidermidis | for C. albicans |
| Coating A1 | −22.4 | 94.38 | 17.5 | 20.3% | 21.7% | 20.0% | 59.0% | 6.0% |
| Coating A2 | −16.2 | 96.61 | 21.5 | 25.8% | 60.3% | 17.0% | 42.0% | * |
| Coating A3 | −12.4 | 68.21 | 17.3 | 45.1% | 77.3% | 26.0% | 80.0% | * |
| Coating A4 | −6.7 | 49.83 | 32.8 | 72.4% | 63.9% | * | * | * |
| Coating A5 | 7.4 | 37.72 | 34.3 | * | * | * | * | 9.0% |
| Coating A6 | 20.7 | 45.41 | 27.6 | * | * | * | 0.0% | 57.0% |
| Coating B1 | −16.2 | 95.58 | 16.4 | 21.9% | 15.2% | 22.0% | 0.0% | 0.0% |
| Coating B2 | −16.5 | 90.77 | 19.9 | 12.9% | 21.9% | 17.0% | 0.0% | * |
| Coating B3 | −9.6 | 67.91 | 25.5 | 39.4% | 57.8% | 13.0% | 0.0% | * |
| Coating B4 | −6.2 | 63.36 | 29.5 | 70.6% | 54.0% | * | * | 19.0% |
| Coating B5 | 6.2 | 51.53 | 19.4 | * | * | * | * | 15.0% |
| Coating B6 | 15.1 | 47.62 | 2.9 | * | * | * | * | 47.0% |
| Coating C1 | −6.8 | 92.28 | 17.5 | 15.2% | 3.7% | 0.0% | 0.0% | 17.0% |
| Coating C2 | 11.8 | 58.59 | 17.9 | 2.1% | 21.8% | 6.0% | 28.0% | 0.0% |
| Coating C3 | 15.7 | 77.79 | 21.1 | 18.1% | 37.9% | 7.0% | 0.0% | 56.0% |
| Coating C4 | 20.2 | 48.04 | 19.1 | 39.9% | 25.7% | 10.0% | 0.0% | 45.0% |
| Coating C5 | 26.3 | 45.94 | 14.5 | * | * | 50.0% | 0.0% | 10.0% |
| Coating C6 | 30.2 | 29.12 | 16.0 | * | * | 78.0% | 0.0% | * |
| Coating D1 | 25.1 | 90.27 | 15.0 | 15.4% | 0.0% | 0.0% | 0.0% | 0.0% |
| Coating D2 | 23.3 | 82.56 | 16.1 | 3.5% | 13.1% | 0.0% | 0.0% | 2.0% |
| Coating D3 | 27.2 | 75.15 | 16.7 | 6.3% | 20.1% | 30.0% | 24.0% | 0.0% |
| Coating D4 | 28.7 | 60.35 | 14.4 | 2.8% | 2.1% | 24.0% | 0.0% | 10.0% |
| Coating D5 | 33.3 | 38.30 | 13.1 | * | * | 39.0% | 0.0% | 0.0% |
| Coating D6 | 33.6 | 66.29 | 22.4 | * | * | 74.0% | 0.0% | 0.0% |

* Coating was not tested

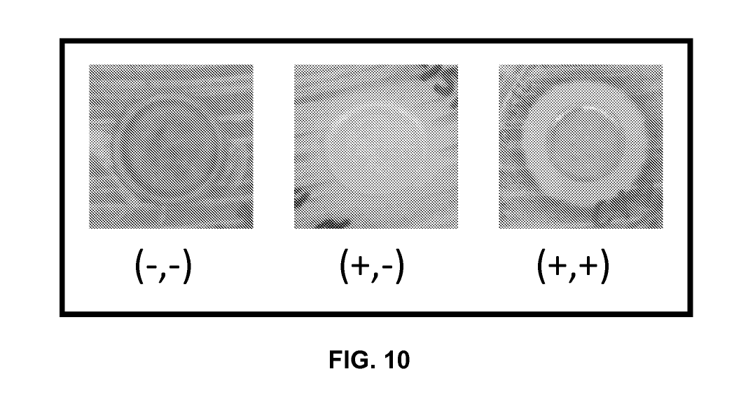

The polyurethane compositions synthesized from acrylic polyols containing QAS moieties were soaked in a silver nitrate solution (45 mg/mL) for various periods of time from 0 to 4 h. The antimicrobial properties were determined using the agar diffusion assay, also known as the Kirby-Bauer disk diffusion assay. Examples of each are shown in FIG. 10. For coatings exhibiting a zone of inhibition, the zones of inhibition were measured and are included in Table 7. In Table 7, (−,−) indicates no surface inhibition and no zone of inhibition; (+,−) indicates surface inhibition but no zone of inhibition; and (+,+) indicates surface inhibition and a zone of inhibition.

TABLE 7
Antimicrobial activity of polyurethane compositions synthesized from polyols containing QAS moieties soaked in silver nitrate.

| | Agar Diffusion Study with | | | | Agar Diffusion study with | | | | Agar Diffusion study with | | | |
|---|---|---|---|---|---|---|---|---|---|---|---|---|
| | Escherichia coli | | | | Candida albicans | | | | Staphylococcus aureus | | | |
| | Immersion time in 45 | | | | Immersion time in 45 | | | | Immersion time in 45 | | | |
| Sample | mg/mL AgNO3 Solution | | | | mg/mL AgNO3 Solution | | | | mg/mL AgNO3 Solution | | | |
| ID | 0 hr | 0.25 hr | 2 hr | 4 hr | 0 hr | 0.25 hr | 2 hr | 4 hr | 0 hr | 0.25 hr | 2 hr | 4 hr |
| Coating C-A1 | (−, −) | (+, +) | (+, +) | (+, +) | (−, −) | (+, +) | (+, +) | (+, +) | (−, −) | (−, −) | (−, −) | (−, −) |
| | | (<1 mm) | (<1 mm) | (<1 mm) | | (10 mm) | (4 mm) | (4 mm) | | | | |
| Coating Q-A5 a | (+, −) | (+, +) | (+, +) | (+, +) | (+, +) | (+, +) | (+, +) | (+, +) | (+, +) | (+, +) | (+, +) | (+, +) |
| | | (2 mm) | (3 mm) | (5 mm) | (2 mm) | (4 mm) | (6 mm) | (6 mm) | (3 mm) | (3 mm) | (4 mm) | (3 mm) |
| Coating Q-A5 b | (−, −) | (−, −) | (+, +) | (+, +) | (−, −) | (+, +) | (+, +) | (+, +) | (−, −) | (−, −) | (−, −) | (−, −) |
| | | | (<1 mm) | (<1 mm) | | (7 mm) | (5 mm) | (8 mm) | | | | |
| Coating C-D1 | (−, −) | (+, +) | (+, +) | (+, +) | (−, −) | (+, +) | (+, +) | (+, +) | (−, −) | (−, −) | (−, −) | (−, −) |
| | | (1 mm) | (<1 mm) | (1 mm) | | (5 mm) | (6 mm) | (5 mm) | | | | |
| Coating Q-D5 a | (+, −) | (+, +) | (+, +) | (+, +) | (+, −) | (+, +) | (+, +) | (+, +) | (+, +) | (+, −) | (+, +) | (+, +) |
| | | (2 mm) | (5 mm) | (7 mm) | | (10 mm) | (7 mm) | (6 mm) | (1 mm) | | (1 mm) | (3 mm) |
| Coating Q-D5 b | (−, −) | (+, +) | (+, +) | (+, +) | (+, −) | (+, +) | (+, +) | (+, +) | (+, −) | (+, −) | (+, −) | (+, −) |
| | | (1 mm) | (3 mm) | (2 mm) | | (5 mm) | (5 mm) | (5 mm) | | | | |

a; iodooctane used as a quaternizing agent
b; iodooctadecane used as a quaternizing agent

In general, the results showed that polyurethane compositions based on polyols containing QAS moieties have better antimicrobial properties after treatment with silver nitrate than the control compositions (no QAS moieties) after treatment with silver nitrate.

### Example 10

### Biocidal Activity of Polyurethane Compositions Against Halmonas Pacifica

In accordance with the MIC test, working solutions for antimicrobial compositions are prepared by dissolving 100 mg of each antimicrobial composition in 10 mL of methanol to generate a 10 mg/mL solution. Next, 10 mL of Guillard's F/2 medium is spiked with 200 μL of the 10 mg/mL antimicrobial composition to achieve a final concentration of 0.2 mg/mL.

A series of dilutions of H. pacifica are prepared by diluting a 0.03 OD₆₀₀ H. pacifica culture in Guillard's F/2 medium to generate concentrations of 100 μg/mL, 50 μg/mL, 25 μg/mL, 12.5 μg/mL, 6.25 μg/mL, 3.13 μg/mL, 1.56 μg/mL, and 0.78 μg/mL. 0.2 mL of each H. pacifica concentration is added in triplicate to a 96-well plate. Additionally, 0.2 mL of Guillard's F/2 medium without any H. pacifica or antimicrobial composition and 0.2 mL of Guillard' s F/2 medium with H. pacifica, but no antimicrobial compositions, serve as negative and positive growth controls, respectively. The 96-well plates are placed in an illuminated growth cabinet with a 16:8 light:dark cycle (photon flux density 33 μmol m⁻² s⁻¹) for 48 hrs at 18° C. and measured for chlorophyll fluorescence using a multi-well plate spectrophotometer (excitation: 360 nm; emission: 670 nm). The efficacy of each antimicrobial composition is measured by determining the percent reduction in diatom growth as a function of antimicrobial composition concentration.

The procedure is repeated to determine the antimicrobial activity of antimicrobial compositions towards a suite of marine microorganisms, namely, Pseudoalteromonas atlantica, Cellulophaga lytica, Cobetia marina, and Halomonas pacifica.

### Example 11

### Survival Rates for Bacteria on Bathroom Handrails

Two commercial ADA-compliant stainless steel handrails (“commercial handrail”) will be cleaned with acetone and ethanol. One handrail will be coated with an antimicrobial polyurethane (“test handrail”). The test handrail will be installed in a stall of a men's bathroom at an international airport. An adjoining stall, having a commercial handrail will be selected as the control. At 5:00 AM, both the test and commercial handrails will be thoroughly disinfected with a bleach solution, and rinsed with clean water. At 10:00 PM, after a full day of use, both handrails will be carefully removed from the stalls and bagged to prevent additional contamination.

The handrails will be taken to a laboratory, where the handrails will be sprayed with a 5 mM solution of CTC (5-Cyano-2,3-ditolyl tetrazolium chloride, commercially available from Sigma-Aldrich, St. Louis, Mo.) under low-light conditions, and then allowed to incubate at 37° C. for 2 hours. After incubation, both handrails will be rinsed with sterile DI water. After air-drying, an ultraviolet lamp will be used to assess the fluorescence on both handrails, the fluorescence being indicative of the presence of active bacteria. The commercial handrail will show a substantially greater amount of fluorescence, indicating that after a full day of use, the test handrail had substantially fewer active bacteria on its surface.

1. An antimicrobial composition comprising a polyurethane having at least one antimicrobial moiety covalently bound to the polyurethane.

2. The antimicrobial composition of claim 1, wherein the polyurethane comprises at least one monomer selected from the group consisting of hydroxyethyl acrylate, butyl acrylate, and triclosan acrylate.

3. The antimicrobial composition of claim 1, wherein at least one antimicrobial moiety comprises triclosan or a triclosan derivative.

4. The antimicrobial composition of any of claim 1, wherein at least one antimicrobial moiety is a quaternary ammonium salt.

5. The antimicrobial composition of claim 4, wherein the quaternary ammonium salt is of Formula (II): 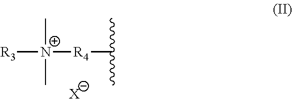
wherein R₃ is alkyl;
R₄ is alkylene, arylene, or heteroarylene; and
X is an anion.

6. The antimicrobial composition of any onc of thc prcccding claims claim 1, wherein the antimicrobial composition further comprises an antimicrobial agent.

7. The antimicrobial composition of claim 6, wherein the antimicrobial agent comprises a metal.

8. The antimicrobial composition of claim 7, wherein the metal is silver.

9. A method of reducing formation of a biofilm on a surface, the method comprising applying to the surface the antimicrobial composition of claim 1.

10. A method of reducing microbial growth on a surface, the method comprising applying to the surface the antimicrobial composition of claim 1.

11. The method of claim 9, wherein the surface is a marine surface.

12. The method of claim 9, wherein the surface is a medical surface.

13. The method of claim 9, wherein essentially no toxic components are leached from the composition.

14. A medical device coated with the antimicrobial composition of claim 1.

15. The medical device of claim 14, wherein the medical device is selected from the group consisting of prosthetic heart valve, urinary catheter, and orthopedic implant.

16. A polyurethane having an antimicrobial moiety covalently bound to the polyurethane.

17. The polyurethane of claim 16 wherein the antimicrobial moiety is triclosan or a triclosan derivative.

18. The polyurethane of claim 16 wherein the antimicrobial moiety is a quaternary ammonium salt.

19. An acrylic polyol having an antimicrobial moiety covalently bound to the acrylic polyol.

20. The polyurethane of claim 19 wherein the antimicrobial moiety is triclosan or a triclosan derivative.

21. The polyurethane of claim 19 wherein the antimicrobial moiety is a quaternary ammonium salt.

22. The method of claim 10, wherein the surface is a marine surface.

23. The method of claim 10, wherein the surface is a medical surface.

24. The method of claim 10, wherein essentially no toxic components are leached from the composition.
